(19) United States
(12) Patent Application Publication
(10) Pub. No.: US 2005/0098482 A1
(43) Pub. Date: May 12, 2005

(54) Handling system for dual side inspection

(76) Inventors: Alan E. Thomas, Clearwater, FL (US); Michael C. Bagley, Palm Harbor, FL (US)

Correspondence Address: COHEN & GRIGSBY, P.C., 11 STANWIX STREET, 15TH FLOOR, PITTSBURGH, PA, 15222, US

(21) Appl. No.: 10/706,434

(22) Filed: Nov. 12, 2003

(51) Int. Cl. B03C 1/00

(52) U.S. Cl. 209/552; 209/214; 209/643

(57) ABSTRACT

The invention is a novel automated apparatus for optically inspecting both sides of manufactured components for manufacturing defects. The invention can be used to inspect either ferrous or non-ferrous components. The apparatus comprises a first and a second rotable disc and either a first and a second nonrotable magnet or a first and second nonrotable vacuum plenum. The first rotable disc rotates in a first direction and the second rotable disc rotates in a second direction. Components are either magnetically held to each disc or held by vacuum. At a transfer station, a bottom surface of the second rotable disc partially overlaps a top surface of the first rotable disc, and components are transferred from the first rotable disc to the second rotable disc.

### FIELD OF THE INVENTION

The invention is directed to automated systems for video inspection and, more particularly, to automated systems for optically inspecting for manufacturing defects on both sides of small components, such as closures or bottle caps that are manufactured at high speed.

### BACKGROUND OF THE INVENTION

Various systems for optically inspecting closures are known in the prior art. When possible, inspection is accomplished during the manufacturing process thereby eliminating the need for additional handling or mechanics. Often, however, inspection during the manufacturing process is either impractical or compromises inspection performance. Thus, there remains a need to inspect components after the manufacturing process is complete. In such a situation, the components can be placed in secondary star-wheels or on conveyer belts to carry them through the inspection area. If inspection is required on both sides of the manufactured item then more elaborate handling is required. For example, a window placed beneath the star-wheel that carries the components across the inspection area can be used, but the window must be constructed in a fashion that permits viewing area to be resistant to damage—thus requiring specific damage-resistant material, which increases cost. Costs are also increased for maintaining such systems if the viewing area in such systems is damaged. Alternatively, more conventional handling processes, such as conveyor belts, can be used wherein the components are placed on a conveyor belt and are inspected on one side and then are inverted and placed in a similar handling system for inspection on the reverse side. There are problems with such systems, however. First, conveyor-type systems have many working parts that must be maintained regularly, which adds to operation cost. Further, if one or more of the working parts fail, the system may have to be shut down for repair. Still further, such systems take up a large amount of space.

Thus, there exists a need for a more aggressive automated handling system that permits high speed inspection, is compact, has less working parts, and is less expensive to operate and maintain.

### SUMMARY OF THE INVENTION

The invention is a novel automated apparatus for optically inspecting both sides of manufactured components for manufacturing defects. The invention can be used to inspect either ferrous or non-ferrous components.

The components to be inspected are directed on to one of two rotable discs. Behind one of the rotable disks is a non-rotable magnet.

The ferrous components are held in place on the rotable disc by the magnetic force exerted upon the component by the nonrotable magnet. The components pass through an inspection station where one side of the component is inspected. The component is then transferred to the other rotable disc. The component, again, is held in place by the magnetic force exerted upon it from another nonrotable magnet which is positioned behind the rotable disc. If the component fails to meet the requirements of inspection, the invention rejects the component.

To inspect nonferrous components, apertures are provided instead of magnets to hold the components on the rotable disc. A vacuum plenum is placed behind the rotable discs and acts upon the components through the apertures to hold the components in place during inspection.

By possessing a pair of rotable discs that convey ferrous components through inspection areas and a pair of nonrotable magnets that alternately hold and release the ferrous components, it is an object of the present invention to provide an automated inspection system that permits high speed dual-sided inspection of the ferrous components without the need for additional handling or mechanics.

By possessing a pair of rotable discs that convey nonferrous components through inspection areas and a pair of nonrotable vacuum plenums that alternately hold and release the non-ferrous components, it is a further object of the invention to provide an automated inspection system that permits high speed dual-sided inspection of nonferrous components without the need for additional handling or mechanics.

It is a further object of the invention to provide an inspection system that is compact and requires less space than conveyor belt-type systems.

It is still a further object of the invention to provide an inspection system that is easier and less costly to operate and maintain.

### BRIEF DESCRIPTION OF THE DRAWINGS

FIG. 1 is a top view of an embodiment invention from the viewpoint of the noninspection side of the second rotable disc.

FIG. 2 is a view of an embodiment of the invention used to inspect ferrous components from the view point of the noninspection side of the first rotable disc.

FIG. 3 is a side view of an embodiment of the invention.

FIG. 4 is a schematic depiction of a rotable disc according to the present invention.

FIG. 5 is a depiction of one embodiment of a rejection assembly according to the present invention.

FIG. 6 is a top view of an embodiment invention that inspects nonferrous components from the viewpoint of noninspection side of the second rotable disc.

### DETAILED DESCRIPTION OF THE PREFERRED EMBODIMENT

The invention is an automated system for optically inspecting both sides of components manufactured at high speed for manufacturing defects.

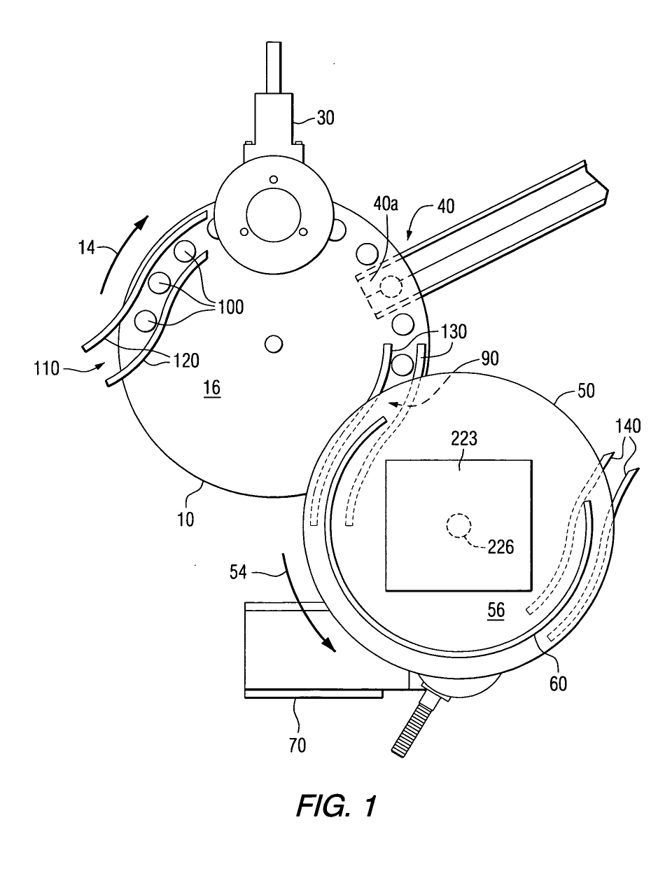

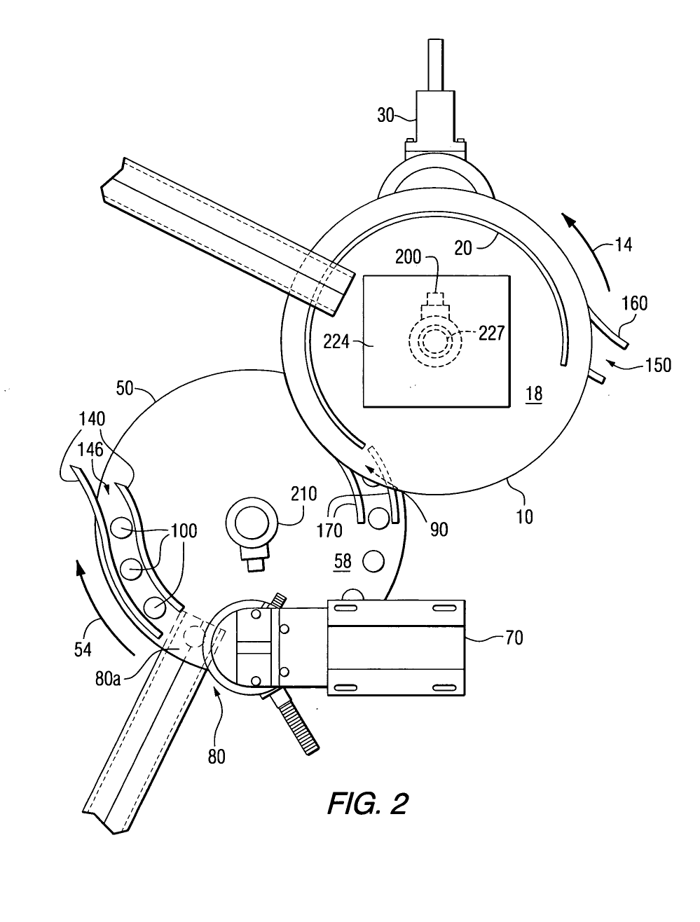

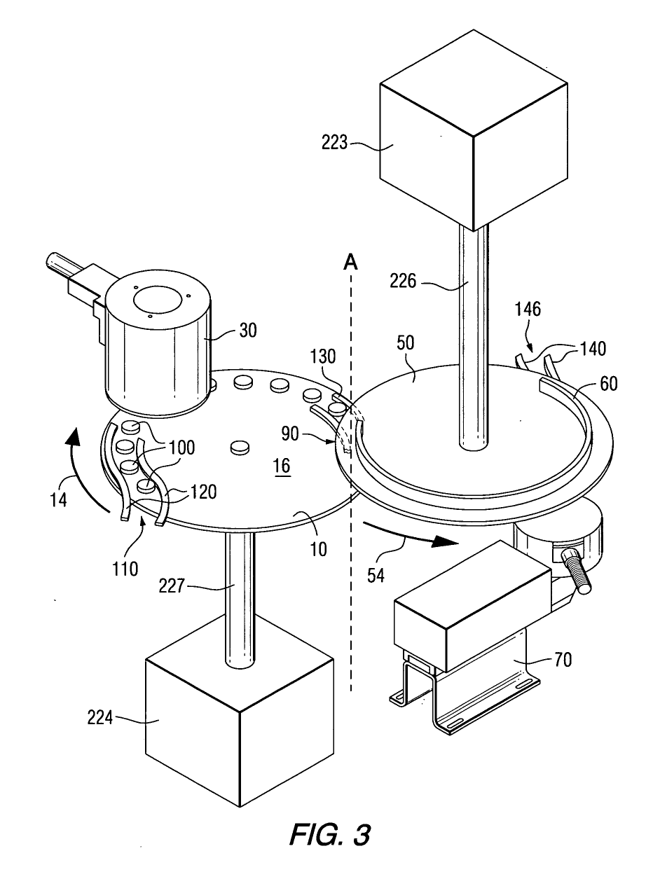

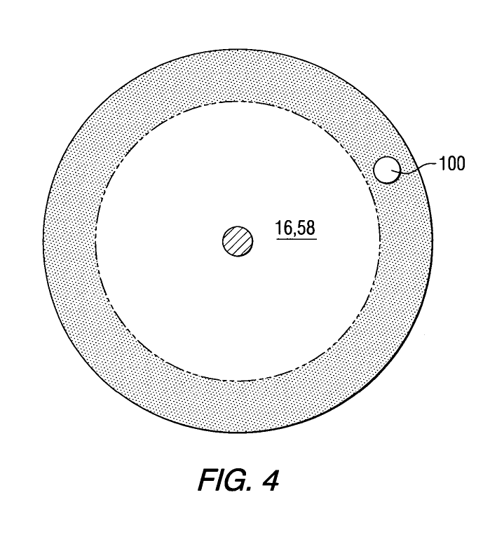

FIGS. 1 through 3 show the preferred embodiment of the apparatus for inspecting ferrous components according to the present invention. The apparatus has a first drive system, which can be any conventional drive system, such as an electric motor, mechanical motor, or other type of motor or mechanical means and which is represented schematically in FIG. 3 as 224. The drive system has a shaft 227. The shaft drivingly connects a first rotable disc 10 and a second rotable disc 50 to the drive or motor. A first nonrotable magnet 20 and a second non-rotable magnet 60 are positioned behind the rotable discs 10 and 50 (adjacent to the non-inspection-side faces of 10 and 50 which are 16 and 56 respectively). First rotable disc 10 is rotatably mounted to the shaft 227 of first drive system 224. In an embodiment, second rotable disc 50 is driven by a second shaft (not shown) of a first drive system 224. Other alternating embodiments will include a second drive system 223 that drives the second rotable disc via a second shaft 226 as shown in FIG. 3. However, it should be noted that any conventional means to drive the disks could be used. The rotable discs 10 and 50 are arranged so that inspection side faces 16 and 58 respectively are facing each other. As schematically depicted in FIG. 4, in a preferred embodiment, each disc has an inspection area that coincides with an area near the perimeter of the disc. The inspection area is the shaded area in FIG. 4. The invention is not limited to having this particular area as the inspection area and contemplates that other areas on the disc may be the inspection area. The rotable discs 10 and 50 face each other and overlap. The point of overlap is depicted as dotted line A in FIG. 3. The first rotable disc 10 rotates in a first direction 14 and the second rotable disc 50 rotates in a second direction 54. A first nonrotable magnet 20 is positioned behind or adjacent to a noninspection side surface 18 of the first rotable disc 10. A second nonrotable magnet 60 is positioned behind or adjacent to a noninspection side surface 56 of second rotable disc 50. At a transfer station 90, where the inspection area of the inspection side surface 58 of the second rotable disc 50 partially overlaps an inspection area of an inspection side surface 16 of the first rotable disc 10, the components 100 are transferred from first rotable disc 10 to second rotable disc 50. This can be achieved because first non-rotable magnet 20 exerts a lower magnetic force and second non-rotable magnet 60 exerts a higher magnetic force at transfer station 90, or by way of an automatic mechanical device that is able to pick the components off of the first rotable disc and place them onto the second rotable disc. FIG. 1 shows components on the inspection side surface 16 of the first rotable disc, while FIG. 2 shows the components 100 on the inspection side surface 58 of the second rotable disc 50 after said components 100 have been transferred.

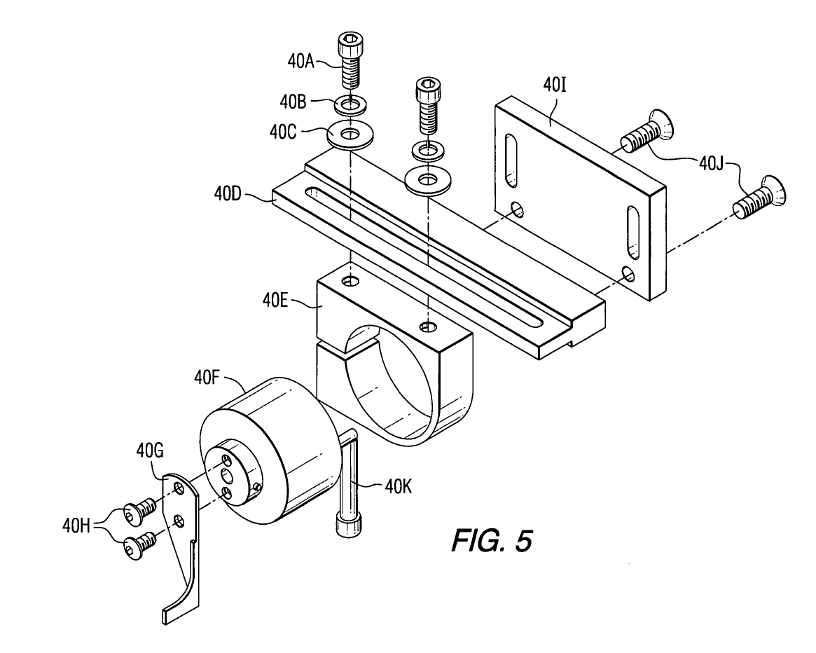

Returning to FIG. 1, FIG. 1 provides a view of the inspection side 16 of the first rotable disk 10. A pair of infeed guards 120 is on the inspection side surface 16 of the first rotable disc 10. A member of the pair of infeed guards 120 is positioned on each side of a first product infeed 110. A first inspection assembly 30 is substantially adjacent to the first rotable disc 10. The inspected components move along the first rotable disc in direction 14 to a first rejection area 40a, which is adjacent to a first rejection assembly 40. At this point, the components are moved off the disc if they do not meet certain inspection criteria. In a preferred embodiment, rejection is accomplished by the rejection assembly 40. An exploded view of a rejection assembly is shown in FIG. 5. The non-rejected components then move to a pair of transfer guards 130 on the inspection surface 16 of the first rotable disc 10. A member of the pair of transfer guards 130 is positioned on each side of the transfer station 90. At this point in the cycle, one side of the components has been inspected.

FIG. 2 shows a view of the preferred embodiment of the apparatus and provides a view of the inspection side of the second rotable disk 50 on which the second sides of the components 100 are inspected after being transferred from first rotable disc 10. A second pair of transfer guards 170 is on a inspection side surface 58 of second rotable disc 50. A member of the second pair of transfer guards 170 is positioned on each side of transfer station 90. A second inspection assembly 70 is substantially adjacent to second rotable disc 50. The inspected components move along the second rotable disc in direction 54 to a second rejection area 80a, which is adjacent to a second rejection station 80. At this point, the components are moved off of the disc if they do not meet certain inspection criteria. In a preferred embodiment, rejection is accomplished by the rejection assembly. An exploded view of such an assembly is shown in FIG. 5, however, one skilled in the art will appreciate that other rejection devices, for example, an air jet, may be used. Optionally, a pair of exit guards 140 is on inspection side surface 58 of second rotable disc 50. A member of the pair of transfer guards 140 is positioned on each side of a product exit station 146. A first encoder 200 is on a bottom surface 18 of first rotable disc 10 and a second encoder 210 is on a bottom surface 58 of second rotable disc 50.

Encoders 200 and 210 connected to the drives shafts 226 and 227 and optionally to the drives 223 and 224 and are used to determine disk rotational distance and speed. Once the component 100 is detected by an infeed sensor (not shown), the component 100 position is tracked. When the component is in the proper position under the inspection stations 30 and 70, inspection data is acquired. Said inspection data can be in the form of an image, which can be acquired through electronic coupling. The data or image information is sent to a process computer (not shown) for analysis. Illumination light (not shown) is generated by a strobe lamp assembly, and directed onto the component 100 by the optical assembly (not shown). The component 100 continues around the disc 10 and 50 to the rejection areas, either 40a or 80a. If analysis of the picture image determines the closure is defective, then a reject signal is sent to the reject assembly 40 or 80 removing the defective components 100 from the respective rotable disc 10 and 50. Acceptable components 100 continue around with the respective discs 10 and 50.

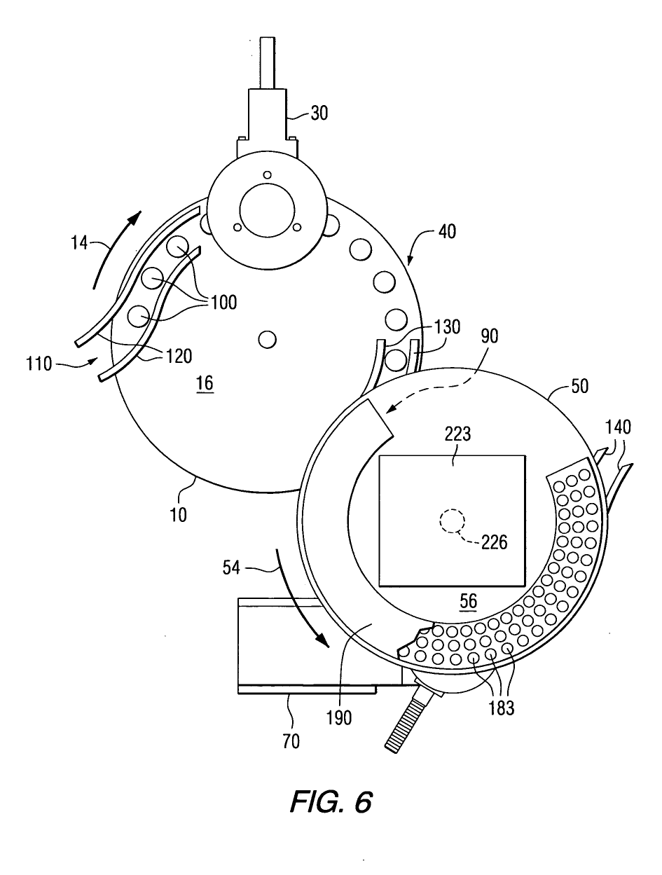

FIG. 6 shows the preferred embodiment for inspecting nonferrous components according to the present invention. The system works in all ways similar to that described above, except that instead of non-rotable magnets, a first (not shown) and a second nonrotable vacuum plenum 190 hold the components 100 in place, and the first and second rotable discs 10, 50 have a plurality of apertures 183. The plurality of apertures 183 provide a means for first and second nonrotable vacuum plenums to hold nonferrous components 100 onto the inspection side surface 16 and 58 of first and second rotable discs 10 and 50. Each nonrotable vacuum plenum is positioned behind the respective rotable disc. At a transfer station 90, inspection side surface 58 of second rotable disc 50 partially overlaps inspection side surface 16 of first rotable disc 10 in the manner depicted in FIG. 3, and components 100 are transferred from first rotable disc 10 to second rotable disc 50 because first non-rotable vacuum plenum exerts a lower vacuum force and second non-rotable vacuum plenum exerts a higher vacuum force at transfer station 90. All other aspects on this inspection system for nonferrous components are the same as that disclosed for the inspection of ferrous components.

While presently preferred embodiments of the invention have been shown and described, the invention may be otherwise within the scope of the appended claims.

1. An apparatus for handling manufactured ferrous components for inspection comprising:
a first rotable disc having an inspection side surface on which said components are carried and a noninspection-side surface, said first rotable disc operable to rotate in a first direction;
a first nonrotable magnet, said first nonrotable magnet adjacent to said noninspection-side surface of said first rotable disc and operable to provide a magnetic force to secure said components to said inspection-side surface of said first rotable disc;
a second rotable disc having an inspection side surface and a noninspection-side surface, said second rotable disc operable to rotate in a second direction and, at a point of overlapping, overlapping a portion of said first rotable disc such that said inspection-side surface of said second rotable disc faces said inspection-side surface of first rotable disc; and
a second nonrotable magnet adjacent to a noninspection-side surface of said second rotable disc, said second nonrotable magnet having a higher magnetic force than said magnetic force of said first nonrotable magnet thereby causing said components to be transferred from said first non-rotable disc to said second nonrotable disc at said point of overlapping and operable to apply magnetic force to secure said components to said inspection-side surface of said second rotable disc.

2. An apparatus for handling manufactured nonferrous components for inspection comprising:
a first rotable disc having an inspection side surface on which said components are carried and a noninspection-side surface, said first rotable disc operable to rotate in a first direction and having a plurality of apertures therethrough;
a first vacuum plenum adjacent to said noninspection-side surface of said first rotable disc and operable to apply a vacuum through said apertures to secure said components to said inspection-side surface of said first rotable disc;
a second rotable disc having an inspection-side surface and a noninspection-side surface, said second rotable disc having apertures therethrough, operable to rotate in a second direction, and at a point of overlapping, overlapping a portion of said first rotable disc such that said inspection-side surface of said second rotable disc faces said inspection-side surface of first rotable disc; and
a second vacuum plenum adjacent to a noninspection-side surface of said second rotable disc and operable to provide a vacuum through said apertures, said vacuum being stronger than said vacuum of said first vacuum plenum thereby causing said components to be transferred from said first nonrotable disc to said second nonrotable disc at said point of overlapping and providing a vacuum to secure said components to said inspection-side surface of said second rotable disc.

3. The apparatus of claims 1 or 2, further comprising:
a first inspection station, said first inspection station being positioned substantially adjacent to said first disc;
a first rejection assembly;
a second inspection station, said second inspection station being positioned substantially adjacent to said second disc; and
a second rejection assembly.

4. The apparatus of claims 1 or 2, further comprising:
an infeed sensor;
a drive shaft;
a shaft encoder, said shaft encoder being mounted on said shaft;
a camera; and
a strobe.

5. An apparatus for handling ferrous components for inspection comprising:
a first rotable disc having an inspection side surface on which said components are carried and a noninspection-side surface, said first rotable disc operable to rotate in a first direction;
a first nonrotable magnet, said first non-rotable magnet adjacent to said non-inspection side surface of said first rotable disc and operable to provide a magnetic force to secure said components to said inspection-side surface of said first rotable disc;
a second rotable disc having an inspection side surface and a noninspection-side surface, said second rotable disc operable to rotate in a second direction, and at a point of overlapping, overlapping a portion of said first rotable disc such that said inspection-side surface of said second rotable disc faces said inspection-side surface of first rotable disc;
a second non-rotable magnet adjacent to a noninspection-side surface of said second rotable disc, said second non rotable magnet operable to apply magnetic force to secure said components to said inspection-side surface of said second rotable disc; and
a transfer station operable to transfer said components from said inspection-side surface of said first rotable disc to said inspection-side surface of said second rotable disc.

6. An apparatus for handling manufactured nonferrous components for inspection, comprising:
a first rotable disc having an inspection-side surface on which said components are carried and a noninspection-side surface, said first rotable disc operable to rotate in a first direction and having a plurality of apertures therethrough;
a first vacuum plenum adjacent to said noninspection-side surface of said first rotable disc and operable to apply a vacuum through said apertures to secure said components to said inspection-side surface of said first rotable disc;
a second rotable disc having an inspection-side surface and a noninspection side surface, said second rotable disc having apertures therethrough and operable to rotate in a second direction, and at a point of overlapping, overlapping a portion of said first rotable disc such that said inspection-side surface of said second rotable disc faces said inspection-side surface of first rotable disc;
a second vacuum plenum adjacent to a noninspection side surface of said second rotable disc and operable to apply a vacuum through said apertures to secure said components to said inspection-side surface of said second rotable disc; and
a transfer station operable to transfer said components from said inspection-side surface of said first rotable disc to said inspection-side surface of said second rotable disc.

7. An apparatus according to claims 1, 2, 5, or 6, wherein said components have a first and second side, said first rotable disc operable for the inspection of said first side of said components and said second rotable disc operable for inspection of said second side of said components.

8. A method of handling components for inspection comprising the steps of:
placing said components on a first rotating disc to inspect a first side of said components;
magnetically securing said components to said first rotating disc;
inspecting said first side of each of said components and providing data of inspection;
analyzing said image to determine whether said component passes or fails pre-selected standards;
rejecting said component if said component fails to meet pre-selected standards;
transferring said component to a second rotating disc to inspect a second side of said components;
magnetically securing said components to said second rotating disc;
inspecting said second side of each of said components and providing data of inspection;
analyzing said data of inspection to determine whether said component passes or fails said pre-selected standards; and
rejecting said component if said component fails to meet preselected standards.

9. The method of claim 8 wherein said step of transferring comprises providing a magnetic force to said second rotating disc that is stronger than a magnetic force applied to said first rotating disc thereby causing said components to be transferred.

10. A method of handling components for inspection comprising the steps of:
placing said components on a first rotating disc to inspect a first side of said components;
securing said components to said first rotating disc by applying a vacuum through apertures in said first rotating disc;
inspecting said first side of each of said components and providing data of inspection;
analyzing said image to determine whether said component passes or fails pre-selected standards;
rejecting said component if said component fails to meet pre-selected standards;
transferring said component to a second rotating disc to inspect a second side of said components;
securing said components to said second rotating disc by applying a vacuum through apertures in said second rotating disc;
inspecting said second side of each of said components and providing data of inspection;
analyzing said data of inspection to determine whether said component passes or fails pre-selected standards; and
rejecting said component if said component fails to meet said pre-selected standards.

11. The method of claim 10 wherein said step of transferring comprises providing a vacuum to said second rotating disc that is stronger than a vacuum force applied to said first rotating disc thereby causing said components to be transferred.
